(19) United States
(12) Patent Application Publication
(10) Pub. No.: US 2009/0302575 A1
(43) Pub. Date: Dec. 10, 2009

(54) HITCH SYSTEM

(76) Inventors: Geoffrey C. Archer, Las Vegas, NV (US); Tim Ignatiuk, Las Vegas, NV (US)

Correspondence Address: WEISS & MOY PC, 4204 NORTH BROWN AVENUE, SCOTTSDALE, AZ, 85251, US

(21) Appl. No.: 12/479,099

(22) Filed: Jun. 5, 2009

Related U.S. Application Data
(60) Provisional application No. 61/058,963, filed on Jun. 5, 2008.

(51) Int. Cl. B60D 1/02; B60D 1/60

(52) U.S. Cl. 280/507; 280/515

(57) ABSTRACT

A hitch assembly for a bomb disposal robot has a female hitch receiver and a pinned flange coupled to the female hitch receiver, the pinned flange for removably attaching the hitch assembly to the ringed drawbar of the bomb disposal robot.

### CROSS-REFERENCE TO RELATED APPLICATION

The application is related to Provisional Patent Application No. 61/058,963, which was filed on Jun. 5, 2008 in the name of the Applicants and to which priority is claimed. This application is also related to Non-provisional patent application Ser. No. 11/809,711, which was filed on Jun. 4, 2007 in the name of the Applicants and which is incorporated herein by reference.

### FIELD OF THE INVENTION

The present invention relates to a hitch system and, more particularly, to a hitch system for a bomb disposal robot to provide increased functionality for the bomb disposal robot.

### BACKGROUND OF THE INVENTION

Presently, many bomb disposal teams are outfitted with a bomb disposal robot. Bomb disposal robots are generally outfitted with cameras, microphones, and sensors for chemical, biological, or nuclear agents. The bomb disposal robot is used to approach suspected devices, and with the use of video technology, a bomb disposal team member can more safely render suspected devices safe. Many of these bomb disposal robots have hand-like manipulators in case a door needs to be opened, or a munition or bomb requires handling or moving.

Once the bomb disposal team member determines what the munition or device is, and what state it is in, the team member will formulate a procedure to disarm it. This may include things as simple as replacing safety features, or as difficult as using high-powered explosive-actuated devices to shear, jam, bind, or remove parts of the item's firing train. Preferably, this will be accomplished remotely.

A bomb disposal robot is limited in functionality to the equipment directly outfitted on the bomb disposal robot. The apparatus and method of the present invention would allow a bomb disposal robot to rapidly couple to a trailer or other device to increase functionality of the bomb disposal robot by allowing it to carry additional equipment, bomb disposal containers, and the like.

### SUMMARY OF THE INVENTION

In accordance with one embodiment of the present invention, a hitch system for a bomb disposal robot is disclosed. The hitch system comprises a female hitch receiver and a pinned flange coupled to the female hitch receiver, the pinned flange for removably attaching the hitch assembly to the bomb disposal robot.

In accordance with another embodiment of the present invention, a hitch system for a bomb disposal robot is disclosed. The hitch system comprises a female hitch receiver comprising: a top surface, a bottom surface, and at least one drawbar connection member extending from a distal end of the female hitch connector; a pinned flange having: a proximal end hingedly coupled to the top surface of the female hitch receiver and a locking pin extending downwardly from a distal end of the pinned flange, the locking pin for removably coupling the at least one drawbar connection member to a ringed drawbar of the bomb disposal robot; and a support rod coupled to the female hitch receiver for moving the pinned flange between an open position and a closed position.

In accordance with another embodiment of the present invention, a hitch system for a bomb disposal robot is disclosed. The hitch system comprises a female hitch receiver comprising: a top surface having an opening, a bottom surface having an opening, and two drawbar connection members extending from a distal end of the female hitch connector, a distal end of each drawbar connection member having an opening for aligning with an opening of a ringed drawbar of the bomb disposal robot; a pinned flange having: a proximal end hingedly coupled to the top surface of the female hitch receiver, a body having an opening, a locking pin extending downwardly from a distal end of the pinned flange, the locking pin for passing through the openings of the two drawbar connection members and the opening of the ringed drawbar of the bomb disposal robot; and a support rod that passes through the openings in the top surface and the bottom surface of the female hitch receiver and wherein a top end of the support rod is coupled to the opening in the body of the pinned flange.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The present invention will become more fully understood from the detailed description and the accompanying drawings, wherein:

FIG. 1 is a perspective view of a hitch system of the present invention, shown in an open position.

FIG. 2 is a side view of the hitch system of FIG. 1.

FIG. 3 is a side view of the hitch system of FIG. 1, shown in a closed position.

FIG. 4 is a side view of a bomb disposal robot shown with the hitch system of FIG. 1 in the open position prior to being attached to a ringed drawbar of the robot.

FIG. 5 is a side view of the bomb disposal robot with the hitch system of FIG. 1 in the closed position and attached to the ringed drawbar of the robot.

### DETAILED DESCRIPTION OF THE PREFERRED EMBODIMENTS

The novel features believed characteristic of the invention are set forth in the appended claims. The invention will best be understood by reference to the following detailed description of illustrated embodiments when read in conjunction with the accompanying drawings, wherein like reference numerals and symbols represent like elements.

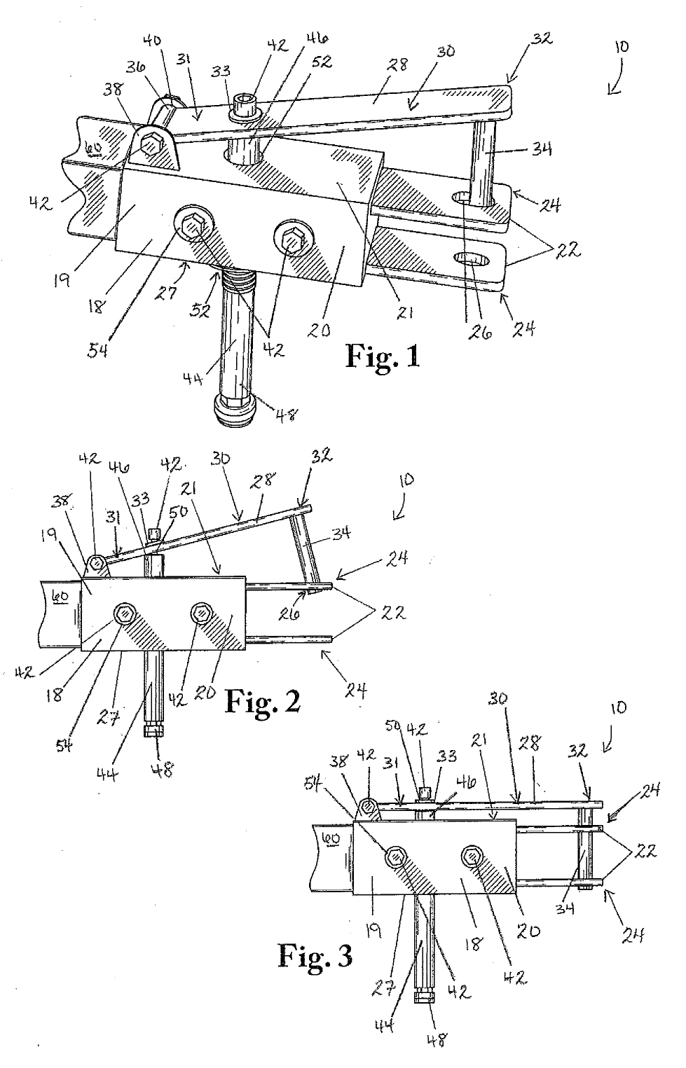

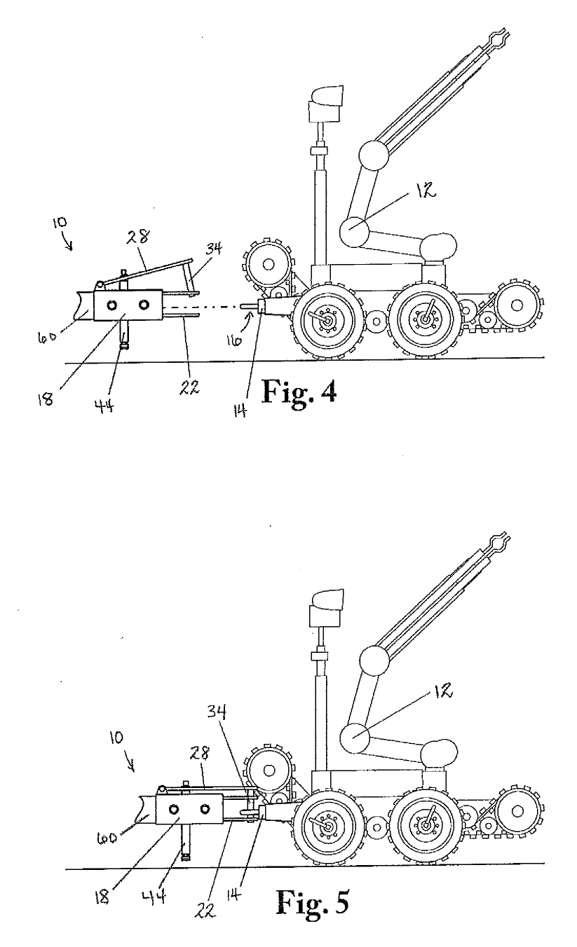

FIGS. 1-5 show an embodiment of a hitch system, hereinafter hitch system 10, for a bomb disposal robot 12 of the present invention. The hitch system 10 will allow the bomb disposal robot 12 to pull a trailer or other towing device. The trailer/towing device would allow the bomb disposal robot 12 to carry additional bomb disposal equipment. By carrying additional equipment, the bomb disposal robot 12 would be able to carry out more functions, thereby increasing the functionality of the bomb disposal robot 12.

The hitch system 10 is specifically designed to be attached to a bomb disposal robot 12 that is equipped with a ringed drawbar 14. The hitch system 10 has a female hitch receiver 18 to receive the hitch 60 of a trailer (not shown) at a proximal end 19. The hitch system 10 also has a pinned flange 28 coupled to the female hitch receiver 18. In one embodiment, a proximal end 31 of the pinned flange 28 has two male securing members 36 projecting outwardly in opposing directions. A top surface 21 of the female hitch receiver 18 has two corresponding female securing members 38 that each have an opening 40 for receiving and coupling to the male securing members 36 of the pinned flange 28. The male securing members 36 may be threaded so that once they are placed through the openings 40 in the female securing members 28, an attachment device 42 such as a nut may be screwed onto the male securing members 36 to hold it them place. While the male securing members 36 and female securing members 38 shown in the figures may be used to create the hinged connection between the proximal end 31 of the pinned flange 28 and the proximal end 19 of the female hitch receiver 18, it should be clearly understood that any suitable alternative coupling means may be used to create the hinged connection. It should also be clearly understood that the pinned flange 28 may be coupled at any point along the top surface 21 of the female hitch receiver 18.

The female hitch receiver 18 may have a drawbar connection member 22 extending outwardly from its distal end 20. While the hitch system 10 is shown as having two drawbar connection members 22 it should be clearly understood that substantial benefit may be derived from only one drawbar connection member 22 or more than two drawbar connection members 22. Each drawbar connection member 22 will have an opening 26 that will be aligned with an opening 16 in the ringed drawbar 14 of the bomb disposal robot 12 While the openings 26 are shown as being formed in a distal end 24 of the drawbar connection members 22, it should be clearly understood that the openings 26 may be formed anywhere along the length of the drawbar connection members 22.

The pinned flange 28 has a locking pin 34 that extends substantially downwardly from a distal end 32 of the body 30 of the pinned flange 28. While it is shown in the figures that the locking pin 34 extends from a bottom surface of the pinned flange 28, it should be clearly understood that the locking pin 34 may be coupled perpendicularly to the distal end 32 of the pinned flange 28. When the openings 26 of the drawbar connection members 22 are aligned with the opening 16 in the ringed drawbar 14, the locking pin 34 of the pinned flange 28 will pass through the openings 26 of the drawbar connection members 22 and the opening 16 of the ringed drawbar 14, thereby securing the hitch system 10 to the bomb disposal robot 12.

The hitch system 10 may have a support rod 44 coupled to the female hitch receiver 18 for moving the pinned flange 28 between an open position (as in FIGS. 1 and 2) and a closed position (as in FIG. 3). The top surface 21 and the bottom surface 27 of the female hitch receiver 18 will each have an opening 52. The support rod 44 will pass through the openings 52 and through the female hitch receiver 18. A top end 46 of the support rod 44 will also be coupled to the body 30 of the pinned flange 28. In one embodiment, the body 30 of the pinned flange 28 will have an opening 33 to receive and secure the top end 46 of the support rod 44. The top end 46 of the support rod 44 may be threaded so that once the top end 46 is passed through the opening 33, an attachment device 42 such as a nut may be screwed onto the top end 46 to secure the support rod 44 to the pinned flange 28. It should be clearly understood that substantial benefit may be derived from the top end 46 of the support rod 44 being welded or otherwise coupled to a bottom surface of the pinned flange 28.

When pressure is applied to a bottom end 48 of the support rod 44, such as when the hitch system 10 is placed on the floor or when a user manually applies pressure to the bottom end 48, the top end 46 of the support rod 44 pushes up against the bottom surface of the pinned flange 28, causing the pinned flange 28 to pivot upwardly into the open position. When this occurs, the locking pin 34 is removed from the openings 26 in the distal ends 24 of the drawbar connection members 22 and the opening 16 of the ringed drawbar 14. Similarly, when pressure is released from the bottom end 48 of the support rod 44, such as when the hitch system 10 is picked up off the floor, the pinned flange 28 pivots downwardly into a closed position. When this happens, the locking pin 34 may be inserted through the openings 26 in the distal ends 24 of the drawbar connection members 22 and the opening 16 of the ringed drawbar 14 to connect the hitch system 10 to the bomb disposal robot 12.

Though not required, the hitch system 10 may have a tension spring 50 coupled to the top end 46 of the support rod 44. The tension spring 50 will help to prevent the pinned flange 28 from opening too wide. The female hitch receiver 18 may also have additional openings 54 to secure the hitch 60 of the trailer/towing device. Corresponding openings in the hitch 60 may be aligned with the openings 54 in the female hitch receiver 18 and secured with an attachment device 42 such as a nut.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A hitch assembly for a bomb disposal robot comprising:
a female hitch receiver; and
a pinned flange coupled to the female hitch receiver, the pinned flange for removably attaching the hitch assembly to the bomb disposal robot.

2. The hitch assembly of claim 1 wherein the female hitch receiver further comprises at least one drawbar connection member extending from one end of the female hitch connector.

3. The hitch assembly of claim 2 wherein the at least one drawbar connection member comprises an opening for aligning with a ringed drawbar of the bomb disposal robot.

4. The hitch assembly of claim 3 wherein the pinned flange of the bitch assembly comprises:
a body; and
a locking pin extending downwardly from a distal end of the body for passing through the opening in the drawbar connection member and the ringed drawbar of the bomb disposal robot.

5. The hitch assembly of claim 1 wherein a proximal end of the pinned flange comprises two outwardly projecting male securing members and wherein a top surface of the female hitch receiver comprises two upwardly projecting female securing members, each upwardly projecting female securing member having an opening for receiving and hingedly coupling to the outwardly projecting male securing members of the pinned flange.

6. The hitch assembly of claim 1 further comprising a support rod coupled to the female hitch receiver for moving the pinned flange between an open position and a closed position.

7. The hitch assembly of claim 6 wherein the female hitch receiver comprises a pair of openings for receiving the support rod and wherein the pinned flange comprises an opening for coupling to a top end of the support rod.

8. The hitch assembly of claim 7 further comprising a tension spring coupled to the top end of the support rod.

9. A hitch assembly for a bomb disposal robot comprising:
a female hitch receiver comprising:
a top surface;
a bottom surface; and
at least one drawbar connection member extending from
a distal end of the female hitch connector;
a pinned flange having:
a proximal end hingedly coupled to the top surface of the female hitch receiver; and
a locking pin extending downwardly from a distal end of the pinned flange, the locking pin for removably coupling the at least one drawbar connection member to a ringed drawbar of the bomb disposal robot; and
a support rod coupled to the female hitch receiver for moving the pinned flange between an open position and a closed position.

10. The hitch assembly of claim 9 further comprising:
two male securing members projecting outwardly from the proximal end of the pinned flange; and
two female securing members projecting upwardly from the top surface of the female hitch receiver for receiving and coupling the two male securing members of the pinned flange.

11. The hitch assembly of claim 9 wherein an opening is formed on a distal end of the drawbar connection member for aligning with an opening of the ringed drawbar of the bomb disposal robot and wherein the locking pin passes through both the opening on the distal end of the drawbar connection member and the opening of the ringed drawbar.

12. The hitch assembly of claim 9 further comprising:
an opening formed in the top surface of the female hitch receiver;
an opening formed in the bottom surface of the female hitch receiver; and
an opening formed in the pinned flange;
wherein the support rod passes through the openings in the top surface and the bottom surface of the female hitch receiver; and
wherein a top end of the support rod is coupled to the opening in the pinned flange.

13. The hitch assembly of claim 12 further comprising a tension spring coupled to the top end of the support rod.

14. The hitch assembly of claim 11 wherein the pinned flange pivots upwardly into the open position as pressure is applied to a bottom end of the support rod and as the locking pin is removed from the opening on the distal end of the drawbar connection member and the opening of the ringed drawbar, and wherein the pinned flange pivots downwardly into the closed position as pressure is removed from the bottom end of the support rod and the locking pin is inserted through the opening on the distal end of the drawbar connection member and the opening of the ringed drawbar.

15. A hitch assembly for a bomb disposal robot comprising:
a female hitch receiver comprising:
a top surface having an opening;
a bottom surface having an opening; and
two drawbar connection members extending from a distal end of the female hitch connector, a distal end of each drawbar connection member having an opening for aligning with an opening of a ringed drawbar of the bomb disposal robot;
a pinned flange having:
a proximal end hingedly coupled to the top surface of the female hitch receiver;
a body having an opening;
a locking pin extending downwardly from a distal end of the pinned flange, the locking pin for passing through the openings of the two drawbar connection members and the opening of the ringed drawbar of the bomb disposal robot; and
a support rod that passes through the openings in the top surface and the bottom surface of the female hitch receiver and
wherein a top end of the support rod is coupled to the opening in the body of the pinned flange.

16. The hitch assembly of claim 15 further comprising a tension spring coupled to the top end of the support rod.

17. The hitch assembly of claim 15 wherein the pinned flange pivots upwardly into an open position as pressure is applied to a bottom end of the support rod and as the locking pin is removed from the openings in the distal ends of the drawbar connection members and the opening of the ringed drawbar.

18. The hitch assembly of claim 15 wherein the pinned flange pivots downwardly into a closed position as pressure is removed from a bottom end of the support rod and the locking pin is inserted through the openings in the distal ends of the drawbar connection members and the opening of the ringed drawbar.

19. The hitch assembly of claim 15 further comprising:
two male securing members projecting outwardly from the proximal end of the pinned flange; and
two female securing members projecting upwardly from the top surface of the female hitch receiver for receiving and coupling the two male securing members of the pinned flange.
